(19) United States
(12) Patent Application Publication
(10) Pub. No.: US 2026/0170261 A1
(43) Pub. Date: Jun. 18, 2026

(54) METHOD AND APPARATUS FOR GENERATING REPLY INFORMATION, AND COMPUTER DEVICE AND STORAGE MEDIUM

(71) Applicant: Tencent Technology (Shenzhen) Company Limited, Shenzhen (CN)

(72) Inventors: Xiuhong ZHU, Shenzhen (CN); Lei YI, Shenzhen (CN); Zeqian HUANG, Shenzhen (CN)

(21) Appl. No.: 19/531,393

(22) Filed: Feb. 5, 2026

Related U.S. Application Data
(63) Continuation of application No. PCT/CN2024/126726, filed on Oct. 23, 2024.

(30) Foreign Application Priority Data
Nov. 10, 2023 (CN) 202311499361 0

(51) Int. Cl. G06F 40/35; G06F 40/279; G06F 40/40

(52) U.S. Cl. CPC G06F 40/35; G06F 40/279; G06F 40/40

(57) ABSTRACT

Disclosed are a method and an apparatus for generating reply information performed by a computer device. The method includes: classifying dialogue information to obtain a category of the dialogue information; when the category of the dialogue information is a first category, performing semantic analysis on the dialogue information through a large language model, to obtain semantic information of the dialogue information; determining a first intention type from a plurality of intention types based on the semantic information, where the first intention type matches the semantic information; and generating first reply information to the dialogue information through a target dialogue model of the first intention type.

### CROSS-REFERENCE TO RELATED APPLICATIONS

This application is a continuation application of PCT Patent Application No. PCT/CN2024/126726, entitled “METHOD AND APPARATUS FOR GENERATING REPLY INFORMATION, AND COMPUTER DEVICE AND STORAGE MEDIUM” filed on Oct. 23, 2024, which claims priority to Chinese Patent Application No. 202311499361.0, entitled “METHOD AND APPARATUS FOR GENERATING REPLY INFORMATION, AND COMPUTER DEVICE AND STORAGE MEDIUM” filed on Nov. 10, 2023, all of which are incorporated herein by reference in their entirety.

### FIELD OF THE TECHNOLOGY

Embodiments of this application relate to the field of computer technologies, and in particular, to a method and an apparatus for generating reply information, and a computer device and a storage medium.

### BACKGROUND OF THE DISCLOSURE

With development of computer technologies, artificial intelligence dialogue is applied increasingly widely. In an artificial intelligence dialogue scenario, a dialogue model is usually trained for the scenario. When a user inputs dialogue information, reply information of the dialogue information is generated by using the dialogue model, and the reply information is outputted, to implement the artificial intelligence dialogue.

### SUMMARY

Embodiments of this application provide a method and an apparatus for generating reply information, and a computer device and a storage medium, to ensure accuracy of reply information. The technical solutions are as follows:

According to one aspect, a method for generating reply information is provided, including:
classifying dialogue information to obtain a first category indicating a plurality of target dialogue models and a second category indicating a general dialogue model;
performing semantic analysis on the dialogue information through a large language model to obtain semantic information of the dialogue information;
determining, based on the semantic information, a first intention type from a plurality of intention types, the first intention type matching the semantic information; and
generating first reply information to the dialogue information through a target dialogue model of the first intention type.

According to another aspect, a computer device is provided. The computer device includes a processor and a memory, the memory storing at least one computer program, and the at least one computer program being loaded and executed by the processor to implement operations performed in the method for generating reply information according to the foregoing aspect.

According to another aspect, a non-transitory computer-readable storage medium is provided. The computer-readable storage medium stores at least one computer program, and the at least one computer program is loaded and executed by a processor to implement operations performed in the method for generating reply information according to the foregoing aspect.

According to still another aspect, a computer program product is provided. The computer program product includes a computer program, and the computer program, when executed by a processor, implements operations performed by the method for generating reply information according to the foregoing aspect.

In the solutions provided in embodiments of this application, the general dialogue model and the plurality of target dialogue models are preset. The plurality of target dialogue models and the general dialogue model belong to different categories. After the dialogue information is obtained, the dialogue information is first classified, to identify which type of dialogue model is configured for replying. When it is determined that the category of the dialogue information is the first category, the semantic information of the dialogue information is analyzed through the large language model, to determine first intention type matching the semantic information from the plurality of intention types by using the semantic information, and further generate corresponding reply information by using the dialogue model of the first intention type. In this way, the dialogue information is roughly screened in a simple binary classification mode, to determine which type of dialogue model is configured for replying. When it is determined that dialogue models of the plurality of intention types are configured for replying, precise matching is performed by using the large language model, to determine an intention type which a dialogue requirement of the dialogue information matches, and then a dialogue model of the determined intention type is configured for replying. In this way, it can be ensured that the configured dialogue model more matches the dialogue requirement of the dialogue information, so that the obtained reply information can accurately reply to the dialogue information, thereby ensuring accuracy of the reply information.

### BRIEF DESCRIPTION OF THE DRAWINGS

FIG. 1 is a schematic structural diagram of an implementation environment according to an embodiment of this application.

FIG. 2 is a flowchart of a method for generating reply information according to an embodiment of this application.

FIG. 3 is a flowchart of another method for generating reply information according to an embodiment of this application.

FIG. 4 is a schematic diagram of classifying dialogue information according to an embodiment of this application.

FIG. 5 is a flowchart of still another method for generating reply information according to an embodiment of this application.

FIG. 6 is a schematic diagram of a ratio of dialogue information according to an embodiment of this application.

FIG. 7 is a schematic structural diagram of an apparatus for generating reply information according to an embodiment of this application.

FIG. 8 is a schematic structural diagram of another apparatus for generating reply information according to an embodiment of this application.

FIG. 9 is a schematic structural diagram of a terminal according to an embodiment of this application.

FIG. 10 is a schematic structural diagram of a server according to an embodiment of this application.

### DESCRIPTION OF EMBODIMENTS

Terms “first”, “second” and the like used in this application may be configured for describing various concepts in this specification. However, the concepts are not limited by the terms unless otherwise specified. The terms are merely used to distinguish a concept from another concept. For example, without departing from the scope of this application, a first category may be referred to as a second category, and similarly, the second category may be referred to as the first category.

Regarding terms “at least one”, “plurality of”, “each”, and “anyone” used in this application, at least one includes one, two, or more, plurality of includes two or more, each refers to each of corresponding plurality of, and anyone refers to any one of plurality of. For example, a plurality of intention types includes three intention types, each refers to each of the three intention types, anyone refers to any one of the three intention types, and may be a first intention type, a second intention type, or a third intention type.

Information (including, but not limited to, user equipment information, user personal information, and the like), data (including, but not limited to, data for analysis, stored data, displayed data, and the like), and signals involved in this application are authorized by a user or sufficiently authorized by all parties. Related data needs to be collected, used, and processed in accordance with related laws and regulations and standards of related countries and regions. For example, dialogue information involved in this application is obtained under sufficient authorization.

A method for generating reply information in related technologies may cause poor accuracy of the reply information.

A method for generating reply information provided in embodiments of this application can be performed by a computer device. In one embodiment, the computer device is a terminal or a server. In one embodiment, the server is an independent physical server, or a server cluster or a distributed system including a plurality of physical servers. In one embodiment, the server is a cloud server providing a basic cloud computing service such as a cloud service, a cloud database, cloud computing, a cloud function, cloud storage, a network service, cloud communication, a middleware service, a domain name service, a security service, a content delivery network (CDN), or a big data and artificial intelligence platform. In one embodiment, the terminal is a smartphone, a tablet computer, a notebook computer, a desktop computer, a smart speaker, a smartwatch, an intelligent voice interaction device, a smart appliance, an in-vehicle terminal, or the like, but is not limited thereto.

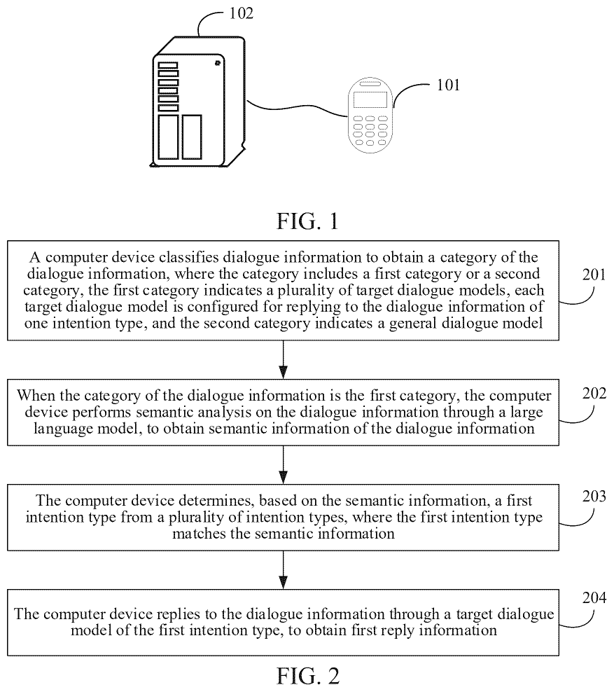

In some embodiments, the computer device is provided as the server. FIG. 1 is a schematic diagram of an implementation environment according to an embodiment of this application. Referring to FIG. 1, the implementation environment includes a terminal 101 and a server 102. The terminal 101 and the server 102 are connected to each other through a wireless or wired network.

The terminal 101 is configured to obtain dialogue information inputted by a user and transmit the dialogue information to the server 102. The server 102 is configured to: receive the dialogue information transmitted by the terminal 101, generate reply information of the dialogue information based on the method for generating reply information provided in this embodiment of this application, and transmit the reply information to the terminal 101, so that the terminal 101 displays the reply information, to implement a human-machine intelligent dialogue.

In some embodiments, an application providing services through the server 102 is installed on the terminal 101, and the terminal 101 can implement functions such as the human-machine intelligent dialogue through the application. In one embodiment, the application is an application in an operating system of the terminal 101, or an application provided by a third party. For example, the application is a dialogue application. The dialogue application has a function of the human-machine intelligent dialogue. Certainly, the dialogue application can further have other functions, such as a comment function, a shopping function, a navigation function, and a game function.

The terminal 101 is configured to log in to the application based on a user identifier, and a dialogue interface can be displayed through the application. The user can input the dialogue information in the dialogue interface through the terminal 101. After obtaining the dialogue information, the terminal 101 transmits the dialogue information to the server 102 through the application. The server 102 is configured to: receive the dialogue information, generate the reply information of the dialogue information based on the method for generating reply information provided in this embodiment of this application, and transmit the reply information to the terminal 101. The terminal 101 receives the reply information, and displays the reply information in the dialogue interface.

FIG. 2 is a flowchart of a method for generating reply information according to an embodiment of this application. The method is performed by the computer device. As shown in FIG. 2, the method includes the following operations:

201: The computer device classifies dialogue information to obtain a category of the dialogue information. The category includes a first category or a second category, the first category indicates a plurality of target dialogue models, each target dialogue model is configured for replying to dialogue information of one intention type, and the second category indicates a general dialogue model.

In this embodiment of this application, the general dialogue model and the plurality of target dialogue models are preset. The plurality of target dialogue models correspond one-to-one with the plurality of intention types, and different target dialogue models correspond to different intention types, so that the plurality of target dialogue models can be subsequently configured for replying to dialogue information of the plurality of intention types, and the general dialogue model is configured for replying to dialogue information not belonging to the plurality of intention types.

In this embodiment of this application, the plurality of target dialogue models are equivalent to dialogue models in a plurality of special scenarios. When the dialogue information is applicable to one of the plurality of special scenarios, the reply information is subsequently generated through one of the plurality of target dialogue models. When the dialogue information is not applicable to the plurality of special scenarios, the reply information is subsequently generated through the general dialogue model. The plurality of target dialogue models and the general dialogue model belong to different categories. When the dialogue information is obtained, the dialogue information is classified to determine which type of dialogue model is configured for subsequent replying to the dialogue information.

The dialogue information may be any type of information. For example, the dialogue information is a text, an image, a video, or the like. The intention type indicates a dialogue intention of the dialogue information, and can reflect a purpose of meaning expressed by the dialogue information. The intention type is of any type. For example, the intention type includes a weather type, a code type, a text-to-image type, or a stock type. The target dialogue model may be any network model, and the general dialogue model may be any network model. For example, both the target dialogue model and the general dialogue model may be large language models.

202: When the category of the dialogue information is the first category, the computer device performs semantic analysis on the dialogue information through the large language model, to obtain semantic information of the dialogue information.

In this embodiment of this application, the category of the dialogue information is the first category, which indicates that the dialogue information possibly matches any intention type of the plurality of intention types. Therefore, semantic analysis is performed on the dialogue information through the large language model, to determine the semantic information of the dialogue information, so that an intention type which the dialogue information matches is subsequently determined based on the semantic information of the dialogue information.

The semantic information may be any type of information. For example, the semantic information is text information.

203: The computer device determines, based on the semantic information, a first intention type from the plurality of intention types. The first intention type matches the semantic information.

In this embodiment of this application, when the semantic information of the dialogue information is determined, the semantic information can indicate semantics of the dialogue information. Therefore, an intention type matching the semantic information can be determined from the plurality of intention types based on the semantics indicated by the semantic information, that is, the intention type matching the dialogue information is determined.

204: The computer device replies to the dialogue information through the target dialogue model of the first intention type, to obtain first reply information.

In this embodiment of this application, if the first intention type matches the dialogue information, the target dialogue model of the first intention type is configured for replying to the dialogue information, to generate the first reply information corresponding to the dialogue information, so that the obtained first reply information matches the dialogue information, thereby ensuring that the first reply information is more accurate.

In the solutions provided in embodiments of this application, the general dialogue model and the plurality of target dialogue models are preset. The plurality of target dialogue models and the general dialogue model belong to different categories. After the dialogue information is obtained, the dialogue information is first classified, to identify which type of dialogue model is configured for replying. When it is determined that the category of the dialogue information is the first category, the semantic information of the dialogue information is analyzed through the large language model, to determine first intention type matching the semantic information from the plurality of intention types by using the semantic information, and further generate corresponding reply information by using the dialogue model of the first intention type. In this way, the dialogue information is roughly screened in a simple binary classification mode, to determine which type of dialogue model is configured for replying. When it is determined that dialogue models of the plurality of intention types are configured for replying, precise matching is performed by using the large language model, to determine an intention type which a dialogue requirement of the dialogue information matches, and then a dialogue model of the determined intention type is configured for replying. In this way, it can be ensured that the configured dialogue model better matches the dialogue requirement of the dialogue information, so that the obtained reply information can accurately reply to the dialogue information, thereby ensuring accuracy of the reply information.

Based on the embodiment shown in FIG. 2, in an embodiment of this application, an example in which the dialogue information is question information is used. The semantic information obtained through the large language model includes an intention type and a question type. Further, the first intention type is determined with reference to a type mapping table. For a specific process, refer to the following embodiment.

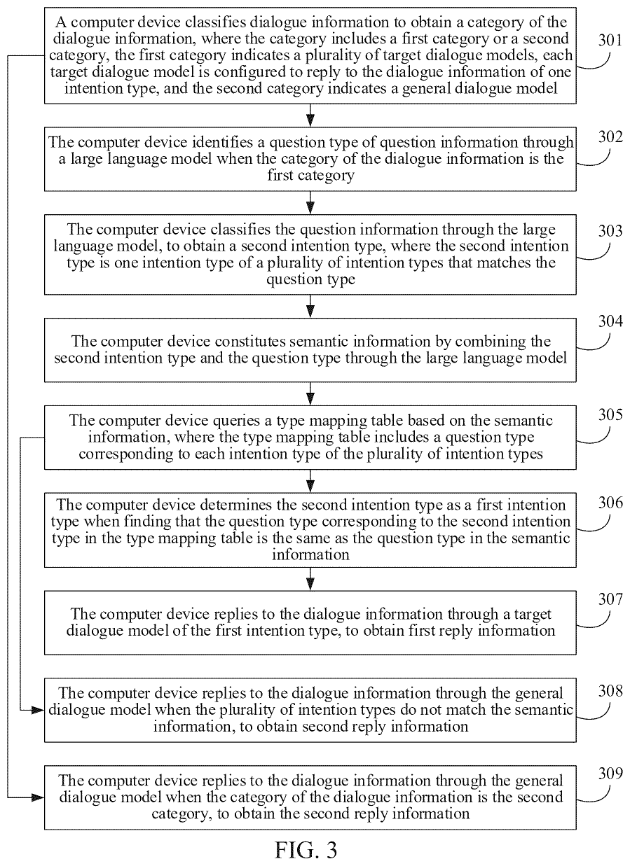

FIG. 3 is a flowchart of a method for generating reply information according to an embodiment of this application. The method is performed by a computer device. As shown in FIG. 3, the method includes the following operations:

301: The computer device classifies dialogue information to obtain a category of the dialogue information. The category includes a first category or a second category, the first category indicates a plurality of target dialogue models, each target dialogue model is configured for replying to the dialogue information of one intention type, and the second category indicates a general dialogue model.

In this embodiment of this application, the dialogue information is question information. For example, the question information is “What's the weather like today” or “Write a piece of code to traverse a folder”.

In a possible implementation, operation 301 includes: classifying the dialogue information through a classification model, to obtain the category of the dialogue information.

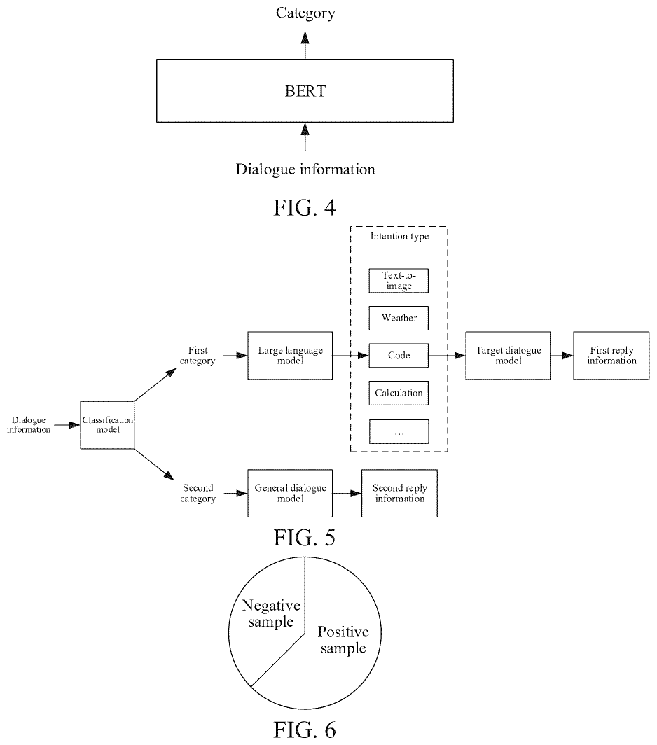

The classification model may be any network model. For example, the classification model is a light model. For example, the light model is a bidirectional encoder representation from transforms (BERT). As shown in FIG. 4, the dialogue information includes n characters, and n is a positive integer. The dialogue information is inputted into the BERT, and the BERT classifies the dialogue information, and outputs the category of the dialogue information.

In this embodiment of this application, the classification model is a binary classification model. The binary classification model is configured for classifying the dialogue information, to determine whether to reply to the dialogue information through one target dialogue model of the plurality of target dialogue models or reply to the dialogue information through the general dialogue model.

302: The computer device identifies a question type of the question information through a large language model when the category of the dialogue information is the first category.

In this embodiment of this application, the dialogue information is the question information, and the question type includes a query type, a programming type, a creation type, and the like. The large language model may be any type of model. For example, the large language model is a generative pre-trained transformer (GPT), and the large language model is obtained by performing supervised fine-tuning (SFT) based on a pre-trained GPT. The GPT is constructed by using a transformer decoder module.

303: The computer device classifies the question information through the large language model, to obtain a second intention type. The second intention type is an intention type of a plurality of intention types that matches the question type.

In this embodiment of this application, the question information is classified through the large language model, to determine the intention type matching the question type of the question information from the plurality of intention types.

For example, if the question information is “Draw a moon”, the question type of the question information is the creation type, and a second intention type matching the creation type is a text-to-image type. If the question information is “Write a quick sorting code”, the question type of the question information is the programming type, and a second intention type matching the programming type is a code type. If the question information is “What's the weather like today”, the question type of the question information is the query type, and a second intention type matching the query type is a weather type. If the question information is “What is 1 plus 1 equal to”, the question type of the question information is a question-and-answer type, and a second intention type matching the question-and-answer type is a calculation type.

304: The computer device constitutes semantic information by combining the second intention type and the question type through the large language model.

In this embodiment of this application, the semantic information includes the second intention type and the question type. When the dialogue information is the question information, the large language model is configured for replying to the dialogue information, to identify the question type of the question information and the second intention type matching the question type, and the semantic information is constituted by combining the second intention type and the question type, so that the semantic information can indicate a type of the question information and a related intention type. In this way, content of the semantic information is enriched, semantic accuracy of indicating the question information by the semantic information is ensured, and accuracy of the semantic information is further ensured, so that an accurate intention type can be subsequently determined based on the semantic information.

In this embodiment of this application, constituting the semantic information by combining the second intention type and the question type is equivalent to combining the obtained second intention type and the question type into the semantic information, so that the obtained semantic information includes the question type of the question information and the second intention type matching the question type. The second intention type and the question type can be obtained through the large language model according to the foregoing operations 302 and 303, and the second intention type and the question type are outputted as a type of information. The outputted information is the semantic information, and the semantic information includes the second intention type and the question type.

In a possible implementation, operation 304 includes: identifying at least one of a topic of the question information, an entity word in the question information, or a word type of the entity word through the large language model, and constituting the semantic information by combining at least one of the topic, the entity word, or the word type, and the second intention type and the question type through the large language model.

The entity word refers to a word having a clear referent, or a word that can represent a specific object, concept, person, place, or the like. For example, the entity word includes apple, weather, today, room, and the like. The word type of the entity word refers to a type to which the entity word belongs. For example, the word type of the entity word includes a time type, a person type, a place type, a group type, and an object type. An entity word of the time type represents a time point or a time period. An entity word of the person type is configured for representing a specific person. For example, the entity word of the person type is a name of a person. An entity word of the group type is configured for representing a specific group. For example, the entity word of the group type is a name of a group. An entity word of the object type represents a particular object. For example, the entity word of the object type is a name of an object.

In this embodiment of this application, the semantic information includes the second intention type and the question information, and further includes at least one of the topic, the entity word, or the word type of the entity word. The large language model is configured for performing feature characterization on the dialogue information in different dimensions, to output the intention type, the topic, the question type, the entity word, or the entity word type, to constitute the semantic information, thereby enriching the content included in the semantic information. In this way, the semantic information can specify semantics of the dialogue information in more details, thereby ensuring accuracy of the semantic information.

In this embodiment of this application, constituting the semantic information by combining at least one of the topic, the entity word, or the word type, and the second intention type and the question type is equivalent to combining at least one of the topic, the entity word, or the word type, and the second intention type and the question type into the semantic information, so that the obtained semantic information includes at least one of the topic, the entity word, or the word type, and the second intention type and the question type. The second intention type and the question type can be obtained through the large language model according to the foregoing method, and at least one of the topic, the entity word, or the word type is obtained. At least one of the topic, the entity word, or the word type, and the second intention type and the question type are outputted as one type of information. The outputted information is the semantic information. The semantic information includes the second intention type and the question information, and further includes at least one of the topic, the entity word, or the word type of the entity word.

For example, the question information is “What's the weather like today”. Using an example in which the semantic information of the question information includes the second intention type, the question information, the topic, the entity word, and the word type of the entity word, in the semantic information of the question information, the second intention type is the “weather type”, the question type of the question information is the “query type”, the topic of the question information is a “weather query”, the entity words in the question information are “today” and “weather”, the word type of “today” is “time”, and the word type of “weather” is a “concept”.

For another example, the question information is “Draw an apple”. Using an example in which the semantic information of the question information includes the second intention type, the question information, the topic, the entity word, and the word type of the entity word, in the semantic information of the question information, the second intention type is the “text-to-image type”, the question type of the question information is the “creation type”, the topic of the question information is “draw”, the entity word in the question information is “apple”, and the word type of the “apple” is “fruit”.

This embodiment of this application is described by using an example in which the second intention type, the question type, and the like are identified through the large language model. In another embodiment, the large language model can further output the semantic information by means of feature extraction and decoding. The outputted semantic information includes the second intention type, the question type, and the like.

In a possible implementation, the semantic information includes a plurality of characters. A process of obtaining the semantic information of the dialogue information includes: performing feature extraction on each character in the dialogue information through the large language model, to obtain a dialogue feature, the dialogue feature including a feature of each character in the dialogue information; updating, for a first character in the dialogue information, a feature of the first character based on the feature of the first character and a feature of a character before the first character in the dialogue information, to obtain an updated feature of the first character, the first character being any character in the dialogue information; forming an updated dialogue feature by using updated features of a plurality of characters in the dialogue information; decoding the updated dialogue feature for the 1^{st} time through the large language model, to obtain the 1^{st} character; decoding the updated dialogue feature for the i^{th} time through the large language model based on a currently acquired character, to obtain the i^{th} character, i being an integer greater than 0; stopping decoding when a quantity of decoding times reaches a threshold of times, or a termination character is obtained through current decoding; and constituting the semantic information by using the obtained characters.

In this embodiment of this application, the feature of each character is updated through features of the plurality of characters in semantic information, and the plurality of characters are gradually obtained through decoding based on an updated semantic feature in a decoding manner, to obtain the semantic information, thereby ensuring accuracy of the obtained semantic information.

In one embodiment, a process of updating the feature of the first character includes: using the feature of the character before the first character in the dialogue information as a first feature and using the feature of the first character as a second feature; determining a first similarity between the second feature and each first feature and a second similarity between the second feature and the second feature; normalizing the first similarity and the second similarity to obtain a third similarity and a fourth similarity, the third similarity being a similarity obtained by normalizing the first similarity, and the fourth similarity being a similarity obtained by normalizing the second similarity; determining a product of each first feature and a corresponding third similarity, and a product of the second feature and the fourth similarity; and determining a sum of the obtained products as the updated feature of the first character.

In this embodiment of this application, a similarity between features can be determined in any manner. For example, the similarity between the features is determined in a manner such as a cosine similarity or a Euclidean distance. For example, both the first feature and the second feature are represented in a vector form, and a product of the first feature and the second feature is determined as a similarity between the first feature and the second feature.

In this embodiment of this application, a sum of the third similarity and the fourth similarity obtained by normalizing the first similarity and the second similarity is 1.

In this embodiment of this application, the feature of the first character is updated based on the feature of the first character and the feature of the character before the first character in the dialogue information. In another embodiment, for each character in the dialogue information, the feature of each character is updated based on features of the plurality of characters in the dialogue information, to obtain an updated feature of each character. For example, the dialogue information includes three characters, a feature of the 1^{st} character, a feature of the 2^{nd} character, and a feature of the 3^{rd} character are respectively updated based on features of the three characters, to obtain an updated feature of the 1^{st} character, an updated feature of the 2^{nd} character, and an updated feature of the 3^{rd} character. A process of updating the feature of each character based on the features of the plurality of characters is the same as the foregoing process of updating the feature of the first character based on the feature of the first character and the feature of the character before the first character, and details are not described herein again.

In one embodiment, a plurality of candidate characters are configured for the large language model, and a decoding process includes: decoding the updated dialogue feature for the 1^{st} time through the large language model, to obtain first probabilities of the plurality of candidate characters, and determining a candidate character of the plurality of candidate characters with the largest first probability as the first character; decoding the updated dialogue feature for the i^{th} time through the large language model based on the currently obtained character, to obtain i^{th} probabilities of the plurality of candidate characters, and determining a candidate character of the plurality of candidate characters with the largest i^{th} probability as the i^{th} character, i being an integer greater than 0; decoding the updated dialogue feature for the j^{th} time through the large language model based on the currently obtained character, to obtain j^{th} probabilities of the plurality of candidate characters; and stopping performing a decoding process when the largest probability of the j^{th} probabilities of the plurality of candidate characters is less than a probability threshold, constituting the semantic information by using currently obtained j−1 characters, and j being an integer greater than i; or stopping performing the decoding process when a candidate character of the plurality of candidate characters with the largest probability of the j^{th} probabilities is a termination character, and constituting the semantic information by using the currently obtained j−1 characters; or when a quantity j of decoding times is equal to the threshold of times determining a candidate character with the largest j^{th} probability in the plurality of candidate characters as the j^{th} character, subsequently stopping performing the decoding process, and constituting the semantic information by using currently obtained j characters.

A first probability of the candidate character is a probability of the candidate character being used as the first character in the semantic information, and the i^{th} probability of the candidate character is a probability of the candidate character being used as the i^{th} character in the semantic information.

In this embodiment of this application, the large language model includes the plurality of candidate characters. The plurality of candidate characters includes all characters as much as possible and includes the termination character. When generating the semantic information of the dialogue information, the large language model selects characters from the plurality of candidate characters to constitute the semantic information. In the decoding process, one character is screened out from the plurality of candidate characters each time. The plurality of characters can be obtained through decoding in such a step-by-step decoding manner. Further, a plurality of characters obtained through decoding constitute the semantic information, thereby ensuring accuracy of the obtained semantic information. In a plurality of decoding processes, if the largest probability of the j^{th} probabilities of the plurality of candidate characters obtained through decoding in a current decoding process is less than the probability threshold, the semantic information is decoded completely. It is unnecessary to select the character from the plurality of candidate characters as a character in the semantic information, thereby ensuring accuracy of the semantic information.

In one embodiment, a process of decoding the updated dialogue features for the j^{th} time based on the currently obtained character includes: performing feature extraction on the currently obtained character through the large language model, to obtain a feature of the currently obtained character; updating the updated feature of each character in the updated dialogue feature based on the feature of the currently obtained character, to obtain a further updated dialogue feature; and decoding the further updated dialogue feature for the j^{th} time, to obtain the j^{th} probabilities of the plurality of candidate characters.

For example, the foregoing dialogue feature obtained after updating each character by using the feature of the character in the dialogue information is referred to as a first dialogue feature. The first dialogue feature is decoded for the first time through the large language model, to obtain the first probabilities of the plurality of candidate characters, and the candidate character of the plurality of candidate characters with the largest first probability is determined as the 1^{st} character. The feature of each character in the first dialogue feature is updated based on the feature of the first character, to obtain a second dialogue feature. The second dialogue feature is decoded for the second time, to obtain second probabilities of the plurality of candidate characters, and a candidate character of the plurality of candidate characters with the largest second probability is determined as the 2^{nd} character. The feature of each character in the second dialogue feature is updated based on the feature of the 1^{st} character and the feature of the 2^{nd} character, to obtain a third dialogue feature. The third dialogue feature is decoded for the third time, to obtain third probabilities of the plurality of candidate characters, and a candidate character of the plurality of candidate characters with the largest third probability is determined as the 3^{rd} character. The rest may be deduced by analogy, to obtain the semantic information.

A process of updating the updated feature of each character in the updated dialogue feature based on the feature of the currently obtained character is similar to the foregoing process of updating the feature of the first character based on the feature of the first character and the feature of the character before the first character, and details are not described herein again.

305: The computer device queries a type mapping table based on the semantic information, the type mapping table including a question type corresponding to each intention type of the plurality of intention types.

In this embodiment of this application, the type mapping table stores the plurality of intention types and the question type corresponding to each intention type, and the question type corresponding to the intention type indicates that a target dialogue model of the intention type can reply to dialogue information belonging to the question type. When the semantic information of the dialogue information is obtained through the large language model, the type mapping table is queried with reference to the second intention type and the question type in the semantic information, to determine a real intention type of the dialogue information, to ensure accuracy of a finally identified intention type.

In this embodiment of this application, the type mapping table stores the plurality of intention types and the question type corresponding to each intention type. The semantic information includes the second intention type and the question type of the question information. The question type corresponding to the second intention type is queried from the type mapping table by using the second intention type included in the semantic information, and the queried question type is compared with the question type of the question information in the semantic information, to determine whether the question type corresponding to the second intention type in the type mapping table includes a question type in the semantic information.

In this embodiment of this application, in the type mapping table, each intention type corresponds to at least one question type. For each question type corresponding to any intention type, the target dialogue model of the intention type can reply to the dialogue information belonging to each question type. In addition, in the type mapping table, different intention types may correspond to different quantities of question types. For example, in the type mapping table, an intention type 1 corresponds to three question types, and an intention type 2 corresponds to one question type.

In a possible implementation, the type mapping table stores at least one of the topic, the entity word, or the word type, and the question type that correspond to each intention type. For example, the type mapping table includes the topic, the entity word, the word type, and the question type that correspond to each intention type.

In this embodiment of this application, when the type mapping table stores the topic corresponding to each intention type, each intention type corresponds to at least one topic. When the type mapping table stores the entity word corresponding to each intention type, each intention type corresponds to at least one entity word. When the type mapping table stores the word type corresponding to each intention type, each intention type corresponds to at least one word type.

306: The computer device determines the second intention type as a first intention type when finding that the question type corresponding to the second intention type in the type mapping table is the same as the question type in the semantic information.

In this embodiment of this application, the semantic information includes the second intention type and the question type, and the type mapping table stores the question type corresponding to each intention type. Therefore, whether the question type corresponding to the second intention type in the type table is the same as the semantic information is queried, to determine whether a target semantic model of the second intention type can reply to the dialogue information. When it is found that the question type corresponding to the second intention type in the type mapping table is the same as the question type in the semantic information, the second intention type is determined as the first intention type, and the first intention type is equivalent to the real intention type of the dialogue information, to determine whether the target semantic model of the first intention type can reply to the dialogue information.

In this embodiment of this application, when the semantic information of the dialogue information is obtained through the large language model, the type mapping table is queried with reference to the intention type and the question type in the semantic information, to determine the real intention type of the dialogue information, and the intention type matching the dialogue information is further verified, to ensure accuracy of the finally identified intention type, further ensure subsequent reply by using a dialogue model matching a dialogue requirement of the dialogue information, thereby ensuring accuracy of subsequent reply information.

This embodiment of this application is described by using an example in which the question type corresponding to the second intention type in the type mapping table is the same as the question type in the semantic information. However, in another embodiment, operation 306 does not need to be performed, and the first intention type is determined in another manner.

In a possible implementation, a process of determining the first intention type includes: determining the second intention type as the first intention type when a target question type includes the question type in the semantic information, the target question type being the question type corresponding to the second intention type in the type mapping table.

In this embodiment of this application, each intention type in the type mapping table corresponds to at least one question type, and the second intention type in the type mapping table corresponds to at least one question type. When the target question type includes the question type in the semantic information, it is determined that the target semantic model of the second intention type can reply to the dialogue information, and then the second intention type is determined as the first intention type.

In a possible implementation, the type mapping table further includes at least one of the topic, the entity word, or the word type that correspond to each intention type. Using an example in which the type mapping table further includes the topic, the entity word, and the word type that correspond to each intention type, operation 306 includes: determining the second intention type as the first intention type when it is found that the topic, the entity word, the word type, and the question type that correspond to the second intention type in the type mapping table are the same as the topic, the entity word, the word type, and the question type in the semantic information.

For example, in the type mapping table, the topic corresponding to the “weather type” is the “weather query”. The question information is “What's the weather like today”. In the semantic information of the question information, the second intention type of the question information is the “weather type”, and the topic is the “weather query”. Based on the semantic information of the question and the type mapping table, it can be determined that the topic in the semantic information is the same as the topic corresponding to “the weather type” in the type mapping table. The “weather type” is the real intention type of the question information, and the “weather type” is determined as the first intention type.

For another example, in the type mapping table, the topic corresponding to the “weather type” is the “weather query”. The question information is an “encyclopedic introduction to weather”. In the semantic information of the question information, the second intention type of the question information is the “weather type”, and the topic is “weather knowledge”. Based on the semantic information of the question and the type mapping table, it can be determined that the topic in the semantic information is different from the topic corresponding to the “weather type” in the type mapping table. The “weather type” is not the real intention type of the question information, and the “weather type” cannot be determined as the first intention type of the question information. Subsequently, the general dialogue model is configured for replying to the question information.

This embodiment of this application is described by using an example in which the topic, the entity word, the word type, and the question type that correspond to the second intention type in the type mapping table are the same as the topic, the entity word, the word type, and the question type in the semantic information. However, in another embodiment, the foregoing operation does not need to be performed, and the first intention type is determined in another manner.

In a possible implementation, the process of determining the first intention type includes: determining the second intention type as the first intention type when the target question type includes the question type in the semantic information, a target topic includes the topic in the semantic information, a target entity word includes the entity word in the semantic information, and a target word type includes the word type in the semantic information, the target question type being the question type corresponding to the second intention type in the type mapping table, the target topic being the topic corresponding to the second intention type in the type mapping table, the target entity word being the entity word corresponding to the second intention type in the type mapping table, and the target word type being the word type corresponding to the second intention type in the type mapping table.

In this embodiment of this application, each intention type in the type mapping table corresponds to at least one question type, each intention type corresponds to at least one topic, each intention type corresponds to at least one entity word, and each intention type corresponds to at least one word type. The second intention type in the type mapping table corresponds to at least one question type, at least one topic, at least one entity word, and at least one word type. When the target question type includes the question type in the semantic information, the target topic includes the topic in the semantic information, the target entity word includes the entity word in the semantic information, and the target word type includes the word type in the semantic information, it is determined that the target semantic model of the second intention type can reply to the dialogue information, and the second intention type is determined as the first intention type.

In this embodiment of this application, the first intention type is determined through the type mapping table. In another embodiment, the foregoing operations 305 and 306 do not need to be performed, and another manner is adopted. The first intention type is determined from the plurality of intention types based on the semantic information of the dialogue information. The first intention type matches the semantic information.

307: The computer device replies to the dialogue information through the target dialogue model of the first intention type, to obtain first reply information.

In this embodiment of this application, if the first intention type is the real intention type to which the dialogue information belongs, the target dialogue model of the first intention type is configured for replying to the dialogue information, to obtain the first reply information, to ensure that the obtained first reply information matches the dialogue information, thereby ensuring accuracy of the obtained first reply information.

For example, the dialogue information is “What's the weather like today”. The dialogue information is classified. When it is determined that the category of the dialogue information is the first category, semantic analysis is performed on the dialogue information through the large language model. Subsequently, it is determined that the real intention type of the dialogue information is the “weather type” through posterior correction for the obtained semantic information. The target dialogue model of the “weather type” is configured for replying to the dialogue information, to obtain the first reply information that “Weather temperature is 26 degrees Celsius today, a sunny day”.

In a possible implementation, a process of replying to the dialogue information includes: performing feature extraction on each character in the dialogue information through the target dialogue model of the first intention type, to obtain the dialogue feature, the dialogue feature including the feature of each character in the dialogue information; updating the feature of each character based on the features of the plurality of characters in the dialogue information, to obtain the updated feature of each character; forming the updated dialogue feature by using the updated features of the plurality of characters in the dialogue information; decoding the updated dialogue feature for the first time through the target dialogue model of the first intention type, to obtain the 1^{st} character; decoding the updated dialogue feature for the i^{th} time based on the currently obtained character though the target dialogue model of the first intention type, to obtain the i^{th} character, i being an integer greater than 0; and stopping decoding when the quantity of decoding times reaches the threshold of times, or the termination character is obtained through current decoding, and constituting the first reply information by using the obtained characters.

The process of replying to the dialogue information is the same as the foregoing process of obtaining the semantic information through the large language model, and details are not described herein again.

308: The computer device replies to the dialogue information through the general dialogue model when the plurality of intention types do not match the semantic information, to obtain second reply information.

In this embodiment of this application, considering that the category obtained by classifying the dialogue information may be inaccurate, leading to a fact that the obtained semantic information does not match the plurality of intention types, to ensure that a reply to the dialogue information can be made, the general dialogue model is configured for replying to the dialogue information. In this way, a subsequent reply can be made in time based on the second reply information, preventing a user from waiting for an excessively long time, and ensuring a real-time reply. An inaccurate reply that is made by one of the plurality of target dialogue models can also be avoided, thereby ensuring accuracy of the reply information.

For example, the semantic information of the dialogue information includes the second intention type, the question type, the topic, the entity word, and the word type. The type mapping table stores the question type, the topic, the entity word, and the word type that correspond to each intention type. The type mapping table is queried based on the semantic information. The target question type is the question type corresponding to the second intention type in the type mapping table, the target topic is the topic corresponding to the second intention type in the type mapping table, the target entity word is the entity word corresponding to the second intention type in the type mapping table, and the target word type is the word type corresponding to the second intention type in the type mapping table. When the target question type does not include the question type in the semantic information, or the target topic does not include the topic in the semantic information, or the target entity word does not include the entity word in the semantic information, or the target word type does not include the word type in the semantic information, it is determined that the plurality of intention types do not match the semantic information.

309: The computer device replies to the dialogue information through the general dialogue model when the category of the dialogue information is the second category, to obtain the second reply information.

In this embodiment of this application, the category of the dialogue information is the second category, which indicates that the dialogue information does not match the plurality of intention types. In this case, the plurality of target dialogue models cannot be configured for replying to the dialogue information. Therefore, the general dialogue model is configured for replying to the dialogue information, to ensure accuracy of the generated second reply information.

A process of replying to the dialogue information through the general dialogue model is the same as the foregoing process of replying to the dialogue information through the target dialogue model of the first intention type, and details are not described herein again.

In the solutions provided in embodiments of this application, the general dialogue model and the plurality of target dialogue models are preset. The plurality of target dialogue models and the general dialogue model belong to different categories. After the dialogue information is obtained, the dialogue information is first classified, to identify which type of dialogue model is configured for replying. When it is determined that the category of the dialogue information is the first category, the semantic information of the dialogue information is analyzed through the large language model, to determine first intention type matching the semantic information from the plurality of intention types by using the semantic information, and further generate corresponding reply information by using the dialogue model of the first intention type. In this way, the dialogue information is roughly screened in a simple binary classification mode, to determine which type of dialogue model is configured for replying. When it is determined that dialogue models of the plurality of intention types are configured for replying, precise matching is performed by using the large language model, to determine an intention type which a dialogue requirement of the dialogue information matches, and then a dialogue model of the determined intention type is configured for replying. In this way, it can be ensured that the configured dialogue model better matches the dialogue requirement of the dialogue information, so that the obtained reply information can accurately reply to the dialogue information, thereby ensuring accuracy of the reply information.

This embodiment of this application provides an intention identification method based on a text general understanding posterior. In the large language model question-answer scenario, first, the dialogue information is roughly screened based on the binary classification model. For the dialogue information that does not belong to the plurality of intention types, the reply information is outputted through the general dialogue model, and for the dialogue information that belongs to the plurality of intention types, the semantic information of the dialogue information is analyzed through the large language model, so that the real intention type of the dialogue information can be determined. The reply information of the dialogue information is outputted through the target dialogue model of the real intention type, to improve efficiency and precision of delivery of a complete intention identification link, thereby ensuring accuracy of the reply information.

Based on the embodiment shown in FIG. 3, a human-machine intelligent dialogue can be implemented through the classification model, the large language model, the plurality of target dialogue models, and the general dialogue model. As shown in FIG. 5, for any dialogue information inputted by any user, the dialogue information is classified through the classification model, to obtain a category of the dialogue information. Semantic analysis is performed on the dialogue information through the large language model when the category of the dialogue information is the first category, to obtain semantic information of the dialogue information. Based on the semantic information and from the plurality of intention types such as a text-to-image intention type, a code intention type, a weather intention type, and a calculation intention type, it is determined that the dialogue information matches the code intention type. A target dialogue model of the code intention type is configured for replying to the dialogue information, to obtain first reply information. When the category of the dialogue information is the second category, the general dialogue model is configured for replying to the dialogue information, to obtain second reply information.

The embodiment shown in FIG. 3 is described by using an example in which the semantic information includes the second intention type and the question type. In another embodiment, the foregoing operations 302 to 304 do not need to be performed, and another manner is adopted. When the category of the dialogue information is the first category, semantic analysis is performed on the dialogue information through the large language model, to obtain the semantic information of the dialogue information.

In a possible implementation, the large language model generates the semantic information with reference to first indication information. To be specific, a process of generating the semantic information includes: obtaining the first indication information, the first indication information indicating the large language model to perform semantic analysis on inputted information according to an example of semantic analysis, and the example including an inputted information example and a semantic information example of the inputted information example; and performing semantic analysis on the dialogue information based on the first indication information through the large language model when the category of the dialogue information is the first category, to obtain the semantic information of the dialogue information.

In this embodiment of this application, the first indication information indicates the semantic information example, and indicates the large language model to perform semantic analysis on the inputted information according to the semantic information example. Because the large language model has a strong reasoning capability, the example of semantic analysis in the first indication information can be learned through the large language model according to the first indication information, to perform semantic analysis on the dialogue information according to the example of semantic analysis, thereby ensuring accuracy of the semantic information.

The first indication information can be represented in any form. For example, the first indication information is a text. The inputted information example and the semantic information example can both be represented in any form. For example, the inputted information example and the semantic information example are both texts.

In one embodiment, the example of semantic analysis in the first indication information includes a positive example and a negative example. The positive example includes an inputted information example and a semantic information example. The negative example includes an inputted information example and a semantic information example. The intention type included in the semantic information example in the positive example indicates the general dialogue model.

For example, using an example in which the inputted information of the large language model is the text, the first indication information is: completing the following text understanding tasks based on an instruction: identifying an intention type to which a question belongs, identifying a topic to which the question belongs, identifying a question type to which the question belongs, identifying an entity word and a word type of the question, the intention type including the text-to-image type, the code type, the calculation type, the weather type, a calendar type, an acrostic poetry type, a map type, a website type, a picture description type, a translation type, and the like. Examples of semantic analysis are as follows: “Input: what's the weather like today, what's the temperature; output: intention type: [weather type], topic: [weather query], question type: [query type], entity word and word type: [today: time| weather: concept]”; “Input: write a piece of code to traverse folders; output: intention type: [code type], topic: [programming], type: [programming type], entity: [ ]”.

Based on the embodiments shown in FIG. 2 and FIG. 3, before the dialogue information is classified through the classification model, the classification model is further trained. A process of training the classification model includes: obtaining a plurality of pieces of sample dialogue information and a sample category corresponding to each piece of sample dialogue information; classifying each piece of sample dialogue information through the classification model, to obtain a predicted category of each piece of sample dialogue information; and training the classification model based on sample categories and predicted categories of the plurality of pieces of sample dialogue information.

In this embodiment of this application, the classification model is the binary classification model configured for classifying the inputted information, to determine that the inputted information belongs to the first category or the second category. The sample category corresponding to the sample dialogue information is the first category or the second category. The sample dialogue information is classified through the classification model, to obtain the predicted category of the sample dialogue information. A difference between the predicted category and the sample category can reflect accuracy of the classification model. The classification model is trained through the predicted category and the sample category, to improve accuracy of the classification model.

The sample dialogue information may be any dialogue information. For example, the sample dialogue information is “What's the weather like today? What's the temperature?”, or “Draw an apple”.

In one embodiment, the sample dialogue information includes positive sample dialogue information or negative sample dialogue information. A sample category corresponding to the positive sample dialogue information is the first category, and a sample category corresponding to the negative sample dialogue information is the second category.

In this embodiment of this application, the plurality of pieces of sample dialogue information includes the positive sample dialogue information and the negative sample dialogue information. A ratio of the positive sample dialogue information to the negative sample dialogue information in the plurality of pieces of sample dialogue information may be any ratio, for example, the ratio of the positive sample dialogue information to the negative sample dialogue information is 6:4. As shown in FIG. 6, in the plurality of pieces of sample dialogue information, 60% of the sample dialogue information is the positive sample dialogue information, that is, 60% of the sample dialogue information belongs to the first category, and 40% of the sample dialogue information is the negative sample dialogue information, that is, 40% of the sample dialogue information belongs to the second category. Because data of the sample dialogue information and the sample category is simple, large-scale data can be generated quickly and efficiently. The classification model only needs to identify whether the inputted information belongs to the first category or the second category, without the need to identify the inputted information belongs to which intention type of the plurality of intention types corresponding to the first category, so that the classification model has a simple structure, enabling rapid training of the classification model.

In one embodiment, a loss value is determined based on the predicted category and the sample category of each piece of sample dialogue information, and the classification model is trained based on the loss value, the loss value representing the difference between the predicted category and the sample category of the sample dialogue information. In this embodiment of this application, the classification model is trained by using a cross-entropy loss, to improve accuracy of the classification model.

Based on the embodiments shown in FIG. 2 and FIG. 3, before the semantic information of the dialogue information is generated through the large language model, the large language model is further trained. A training process is performed by the computer device, and the training process includes the following operations:

Operation 1: The computer device obtains the sample dialogue information and second indication information, the second indication information indicating a semantic analysis model to perform semantic analysis on the inputted information according to the example of semantic analysis.

In this embodiment of this application, the second indication information indicates the semantic analysis model to complete a semantic analysis task according to an indication, and indicates the example of semantic analysis, so that the semantic analysis model subsequently completes the semantic analysis task based on the indication information.

The sample dialogue information is any dialogue information. For example, the sample dialogue information is “What's the weather like today? What's the temperature?”, or “Draw an apple”. The semantic analysis model is a large language model whose training is completed.

Operation 2: The computer device performs semantic analysis on the sample dialogue information based on the second indication information through the semantic analysis model, to obtain sample semantic information.

In this embodiment of this application, the semantic analysis model has a strong reasoning function, and can process the inputted information based on inputted indication information, to implement a task indicated by the indication information. The second indication information indicates the semantic analysis model to complete the semantic analysis task, and the semantic analysis model can perform semantic analysis on the sample dialogue information according to content indicated by the second indication information, to obtain the sample semantic information of the sample dialogue information.

In this embodiment of this application, the second indication information indicates the example of semantic analysis, and indicates the large language model to perform semantic analysis on the inputted information according to the semantic information example. Because the semantic analysis model has the strong reasoning capability, the example of semantic analysis in the second indication information can be learned through the semantic analysis model according to the second indication information, to perform semantic analysis on the sample dialogue information according to the example of semantic analysis, thereby ensuring accuracy of the sample semantic information.

In this embodiment of this application, the semantic analysis model can perform a task based on the indication information, and the semantic analysis model is a trained model. Therefore, the sample semantic information obtained through the semantic analysis model is sufficiently accurate.

Operation 3: The computer device performs semantic analysis on the sample dialogue information through the large language model, to obtain predicted semantic information.

Operation 3 is similar to the foregoing operation 202, and details are not described herein again.

Operation 4: The computer device trains the large language model based on the predicted semantic information and the sample semantic information.

In this embodiment of this application, a difference between the predicted semantic information and the sample semantic information can reflect accuracy of the large language model. A smaller difference between the predicted semantic information and the sample semantic information indicates a more accurate large language model, and a greater difference between the predicted semantic information and the sample semantic information indicates a less accurate large language model. Therefore, the large language model is trained based on the predicted semantic information and the sample semantic information, to improve the accuracy of the large language model.

In a possible implementation, operation 4 includes: substituting the predicted semantic information and the sample semantic information into a cross-entropy loss function, to obtain the loss value, and adjusting a model parameter of the large language model by using the loss value.

In this embodiment of this application, the cross-entropy loss function is configured for calculating a loss. The predicted semantic information and the sample semantic information are substituted into the cross-entropy loss function, to obtain the loss value. The loss value can represent the difference between the predicted semantic information and the sample semantic information. The greater the difference between the predicted semantic information and the sample semantic information, the larger the loss value, and the smaller the difference between the predicted semantic information and the sample semantic information, the smaller the loss value. The model parameter of the large language model can be adjusted by using the loss value, to train the large language model.

In the solution provided in this embodiment of this application, the semantic analysis model is a large language model that is completely trained and has a strong reasoning function. When the sample dialogue information is obtained, the sample semantic information of the sample dialogue information can be obtained by using the semantic analysis model, ensuring accuracy of the sample semantic information. Further, the predicted semantic information of the sample dialogue information is predicted through the large language model based on the sample dialogue information and the sample semantic information. The large language model is trained based on the difference between the predicted semantic information and the sample semantic information, ensuring a training effect of the large language model, and improving the accuracy of the large language model.

In the foregoing embodiment, the large language model is trained based on the predicted semantic information and the sample semantic information that are outputted by the large language model. In another embodiment, semantic analysis is performed on the sample dialogue information through the large language model, to obtain the predicted semantic information the same as the sample semantic information and a probability of each character in the predicted semantic information, and the large language model is trained based on the probability of each character in the predicted semantic information.

In this embodiment of this application, when the large language model performs semantic analysis on the sample dialogue information, the plurality of characters are outputted in a character-by-character decoding manner, and the outputted characters constitute the predicted semantic information. The sample semantic information is real semantic information of the sample dialogue information. Therefore, when semantic analysis is performed on the sample dialogue information through the large language model, the large language model is controlled, according to the sample semantic information, to output the predicted semantic information the same as the sample semantic information, and the probability of each character in the predicted semantic information is determined. Therefore, the probability of each character in the predicted semantic information can reflect accuracy of the large language model. A greater probability of each character in the predicted semantic information indicates a greater probability that the large language model outputs the predicted semantic information the same as the sample semantic information, and a smaller probability of each character in the predicted semantic information indicates a smaller probability that the large language model outputs the predicted semantic information the same as the sample semantic information. Therefore, the large language model is trained based on the probability of each character in the predicted semantic information, to improve the accuracy of the large language model.

In one embodiment, a process of obtaining the predicted semantic information the same as the sample semantic information and the probability of each character in the predicted semantic information through the large language model includes: performing feature extraction on each character in the sample dialogue information through the large language model, to obtain a sample dialogue feature, the sample dialogue feature including a feature of each character in the sample dialogue information; updating, for a second character in the sample dialogue information, a feature of the second character based on the feature of the second character and a feature of a character before the second character in the dialogue information, to obtain an updated feature of the second character, the second character being any character in the sample dialogue information; forming an updated sample dialogue feature by using updated features of a plurality of characters in the sample dialogue information; decoding the updated sample dialogue feature for the 1^{st} time through the large language model, to obtain first probabilities of a plurality of candidate characters in the large language model, and determine a first probability of the 1^{st} character in the sample semantic information; decoding the updated sample dialogue feature for the 2^{nd} time through the large language model based on the 1^{st} character in the sample semantic information, to obtain second probabilities of the plurality of candidate characters, and determine a second probability of the 2^{nd} character in the sample semantic information; decoding the updated sample dialogue feature for the (k+1)^{th} time through the large language model based on first k characters in the sample semantic information, to obtain (k+1)^{th} probabilities of the plurality of candidate characters, and determine a (k+1)^{th} probability of the (k+1)^{th} character in the sample semantic information; and repeating the foregoing process until a probability of the last character in the sample semantic information is determined. In this case, the predicted semantic information the same as the sample semantic information and the probability of each character in the predicted semantic information are obtained. k is an integer greater than 1.

In a possible implementation, when the predicted semantic information is the same as the sample semantic information, a process of training the large language model includes: determining the loss value based on the probability of each character in the predicted semantic information, and training the large language model based on the loss value.

In one embodiment, the large language model is configured to minimize a maximum likelihood function, to determine the loss value, and the loss value satisfies the following relationship:

$${L}_{1} ( u ) = {\sum }_{i} log P ( {u}_{i} \vert {u}_{i - k} , … , {u}_{i - 1} ; Θ )$$

L₁(u) is configured for representing the loss value, Θ is configured for representing the sample semantic information, i is configured for representing a sequence number of the character in the sample semantic information, i is an integer greater than 1, uᵢ₋₁ is configured for representing the (i−1)^{th} character in the sample semantic information, uᵢ₋ₖ is configured for representing the (i−k)^{th} character in the sample semantic information, uᵢ is configured for representing the i^{th} character in the sample semantic information, k is an integer greater than 0, and k represents a window size, and P(uᵢ|uᵢ₋ₖ, . . . , uᵢ₋₁;Θ) is configured for representing a probability of obtaining the i^{th} character in the sample semantic information when it is obtained that first k characters in the predicted semantic information are the same as the first k characters in the sample semantic information, that is, the probability of the i^{th} character is predicted by using the first k characters in the sample semantic information.

In this embodiment of this application, the large language model is obtained by performing SFT based on the pre-trained GPT in an autoregressive manner, and the GPT is constructed by using the transformer decoder module. When performing semantic analysis on the dialogue information, the transformer decoder outputs the plurality of characters in the step-by-step decoding manner, and the plurality of outputted characters constitute the semantic information. In a process of outputting the plurality of characters, a next character is outputted based on the dialogue information and the currently obtained character. In a process of training the transformer decoder, semantic analysis is performed on the sample dialogue information, the predicted semantic information the same as the sample semantic information is outputted character by character according to the sample semantic information, and in a process of outputting the predicted semantic information, the next character is outputted based on the currently obtained character, that is, a next token is predicted through a current token and a token before the current token, and a character after the currently obtained character in the sample semantic information is masked.

The transformer decoder can more efficiently capture a long-distance dependency relationship of sequence data. The transformer decoder includes a plurality of masked self-attention layers and a position-wise feed-forward neural network that are stacked together through residual connection and layer normalization. Self-attention captures context-related information in a sequence through a self-attention mechanism. Calculation of self-attention involves three weight matrices (a query matrix Q, a key matrix K, and a value matrix V), and a final attention weight is calculated through dot product, scaling, Softmax activation, and weighted sum. Masked self-attention uses a mask to cover information after the current token in the self-attention mechanism, to ensure that prediction is based on only previous token information. Layer normalization is to accelerate model convergence. Each layer is normalized through layer normalization after being outputted, to reduce a problem of gradient vanishing/exploding in a network.

Parameters of the transformer decoder may be any parameters. For example, the parameters of the transformer decoder are set as follows: a model size (MODEL_SIZE) is 7 Billion (7B), a quantity of network layers (NUM_LAYERS) is 32, a size of a hidden layer (HIDDEN_SIZE) is 4096, a quantity of multi-head self-attention (NUM_ATTN_HEADS) is 32, a size of a hidden layer of a feedforward neural network (FFN_HIDDEN_SIZE) is 16384, and a size of a self-attention layer (ATTN_HEAD_SIZE) is 128. The large language model can also perform SFT through a GPT model with larger-scale parameters.

In the foregoing embodiment, training data of the large language model includes the sample dialogue information and the sample semantic information. When the training data of the large language model is constructed, the sample dialogue information is constructed based on an in context learning (ICL) method, and the sample semantic information of the sample dialogue information is obtained through the semantic analysis model. Further, the sample dialogue information and the sample semantic information can constitute the training data of the large language model. The training data constructed in this manner can cover a plurality of natural language processing (NLP) tasks, including an intention type, a topic, a question type, entity recognition, and the like.

In a process of constructing the training data of the large language model, the second indication information of the semantic analysis model is first constructed. The second indication information indicates a task that the semantic analysis model needs to execute and the example of semantic analysis.

The task that the semantic analysis model needs to execute indicates the semantic analysis model to complete the following text understanding tasks based on an instruction: identifying an intention type to which a question belongs, identifying a topic to which the question belongs, identifying a question type to which the question belongs, identifying an entity word and a word type of the question, the intention type including the text-to-image type, the code type, the calculation type, the weather type, the calendar type, the acrostic poetry type, the map type, the website type, the picture description type, the translation type, and the like. Examples of semantic analysis are as follows: “Input: what's the weather like today, what's the temperature; output: intention type: [weather type], topic: [weather query], question type: [query type], entity word and word type: [today: time; weather: concept]”; “Input: write a piece of code to traverse folders; output: intention type: [code type], topic: [programming], type: [programming type], entity: [ ]”.

The example of semantic analysis in the second indication information indicates input and output of the semantic analysis model. For example, when the input of the semantic analysis model is “What's the weather like? What's the temperature”, an outputted “plug-in” of the semantic analysis model is a “weather plug-in”, the “topic” is the “weather query”, the “question type” is the “query type”, and the “entity word” is stored in a manner of “entity word: word type”, and a plurality of entities are separated by “|”, including “today: time” and “weather: concept”. The example of semantic analysis in the second indication information includes positive and negative examples of the plurality of intention types. For example, using the “weather intention type” as an example, the positive example is (“What's the weather like? What's the temperature”) and a confusing negative example (“Can we attend a camping concert on Friday?”). Other intention types are similar. The semantic information outputted by the semantic analysis model includes the intention type, the topic, the question type, the entity word, and the word type. In this embodiment of this application, an example in which the semantic information includes the intention type, the topic, the question type, the entity word, and the word type is only configured for description. In a plurality of NLP understanding tasks, content of the semantic information can be flexibly increased or decreased.

For example, examples of semantic analysis in the second indication information are as follows:

“Input: What's the weather like today? What is the temperature today?; output: intention type: [weather type], topic: [weather query], question type: [query type], entity: [today: time|weather: concept]”; “Input: Can we attend a camping concert on Friday?; output: intention type: [general dialogue model], topic: [activity invitation], question type: [consultation type], entity: [Friday: time|camping concert: activity]”; “Input: Write a piece of code to traverse folders; output: intention type: [code type], topic: [programming], question type: [programming type], entity: [ ]”; “Input: What is a difference between a linear regression function and a coding function?; output: intention type: [general dialogue model], topic: [programming], question type: [introduction type], entity: [ ]”; “Input: Draw an apple; output: intention type: [text-to-image type], topic: [draw], question type: [creation type], entity: [apple: fruit]”; and “Input: Describe a picture: an animal sleeps in a wardrobe, with a fan blowing; output: intention type: [general dialogue model], topic: [image description], question type: [description type], entity: [animal: animation image|wardrobe: object|fan: object]”.

Based on the foregoing second indication information, using an example in which the sample dialogue information is “Describe a picture: students are playing basketball”, semantic analysis is performed on the sample dialogue information through the semantic analysis model based on the second indication information, and the obtained sample semantic information is “intention type: [general dialogue model], topic: [image description], question type: [description type], entity: [student: character|play basketball: activity]”.

After the training data is obtained through the foregoing semantic analysis model, the training data can be screened, and the large language model is trained by using the screened training data. In this embodiment of this application, the sample dialogue information and corresponding sample semantic information are used to constitute a piece of training data through a sample information template provided in this embodiment of this application. The sample information template and the training data are as follows: “input: {dialogue information} output: {reply information}”. For example, the training data is “Input: What is 1.1 to the power of 7; output: intention type: [calculation type], topic: [mathematical question], question type: [calculation type], entity: [power: mathematical concept]”.

In a possible implementation, a template of the large language model is further constructed. The template includes input and output of the large language model. The inputted information of the large language model is used as a text, and the large language model replies to the inputted information to obtain the reply information. The dialogue information and the reply information can constitute the following template: “input: {dialogue information} output: {reply information}”.

According to the method provided in this embodiment of this application, accuracy of the reply information can be ensured. In the solution provided in this embodiment of this application, the dialogue model includes the general dialogue model and the plurality of target dialogue models, training data of the general dialogue model and the plurality of target dialogue models is easily constructed, training data of each dialogue model can be rapidly generated, and then each dialogue model is trained based on the training data of each dialogue model. Identification of an intention type to which the dialogue information belongs is processed by the large language model, and training of the large language model only needs training data of a small scale and high quality. Because the classification model has a low requirement on configuration and video memory, and the large language model has a high requirement on configuration and video memory, the category of the dialogue information is identified through the binary classification model, so that only the dialogue information that belongs to the first category is distributed to the large language model for intention identification, and it is unnecessary to process each piece of dialogue information through the large language model. In this way, resources of a device can be saved.

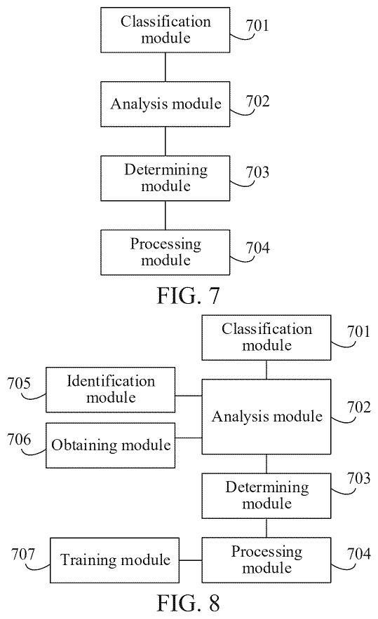

FIG. 7 is a schematic structural diagram of an apparatus for generating reply information according to an embodiment of this application. As shown in FIG. 7, the apparatus includes:
a classification module 701, configured to classify dialogue information to obtain a category of the dialogue information, the category including a first category or a second category, the first category indicating a plurality of target dialogue models, each target dialogue model being configured for replying to dialogue information of one intention type, and the second category indicating a general dialogue model;
an analysis module 702, configured to perform semantic analysis on the dialogue information through a large language model when the category of the dialogue information is the first category, to obtain semantic information of the dialogue information;
a determining module 703, configured to determine, based on the semantic information, a first intention type from a plurality of intention types, the first intention type matching the semantic information; and
a processing module 704, configured to reply to the dialogue information through a target dialogue model of the first intention type, to obtain first reply information.

In a possible implementation, the dialogue information is question information. The analysis module 702 is configured to identify a question type of the question information through the large language model when the category of the dialogue information is the first category. The question information is classified through the large language model, to obtain a second intention type. The second intention type is an intention type of the plurality of intention types that matches the question type. The semantic information is constituted by combining the second intention type and the question type through the large language model.

In another possible implementation, as shown in FIG. 8, the apparatus further includes:
an identification module 705, configured to identify at least one of a topic of the question information, an entity word in the question information, or a word type of the entity word through the large language model; where
the analysis module 702 is configured to constitute the semantic information by combining at least one of the topic, the entity word, or the word type, and the second intention type and the question type through the large language model.

In another possible implementation, the determining module 703 is configured to: query a type mapping table based on the semantic information, the type mapping table including a question type corresponding to each intention type in the plurality of intention types; and determine the second intention type as the first intention type when it is found that a question type corresponding to the second intention type in the type mapping table is the same as a question type in the semantic information.

In another possible implementation, the determining module 703 is configured to: query the type mapping table based on the semantic information, the type mapping table including the question type corresponding to each intention type in the plurality of intention types; and determine the second intention type as the first intention type when target question type includes the question type in the semantic information, the target question type being a question type corresponding to the second intention type in the type mapping table.

In another possible implementation, as shown in FIG. 8, the apparatus further includes:
an obtaining module 706, configured to obtain first indication information, the first indication information indicating the large language model to perform semantic analysis on inputted information according to an example of semantic analysis, the example including an inputted information example and a semantic information example of the inputted information example; where
the analysis module 702 is configured to perform semantic analysis on the dialogue information through the large language model based on the first indication information when the category of the dialogue information is the first category, to obtain the semantic information of the dialogue information.

In another possible implementation, the processing module 704 is further configured to reply to the dialogue information through the general dialogue model when the category of the dialogue information is the second category, to obtain second reply information.

In another possible implementation, the processing module 704 is further configured to reply to the dialogue information through the general dialogue model when the plurality of intention types do not match the semantic information, to obtain the second reply information.

In another possible implementation, as shown in FIG. 8, the apparatus further includes:
the obtaining module 706, configured to obtain sample dialogue information and second indication information, the second indication information indicating semantic analysis model to perform semantic analysis on the inputted information according to the example of semantic analysis; where
the analysis module 702 is further configured to perform semantic analysis on the sample dialogue information based on the second indication information through the semantic analysis model, to obtain sample semantic information; and
the processing module 704 is further configured to reply to the sample dialogue information through the large language model, to obtain predicted semantic information; and
a training module 707, configured to train the large language model based on the predicted semantic information and the sample semantic information.

The apparatus for generating reply information provided in the foregoing embodiments is merely described by using an example of division of the foregoing functional modules. During actual application, the foregoing functions may be allocated to different functional modules to be completed according to a requirement, that is, an inner structure of a computer device is divided into different functional modules to complete all or some of the functions described above. In addition, the apparatus for generating reply information provided in the foregoing embodiments and the embodiments of the method for generating reply information fall within a same conception. For details of a specific implementation process, refer to the method embodiments. Details are not described herein again.

An embodiment of this application further provides a computer device. The computer device includes a processor and a memory. The memory stores at least one computer program. The at least one computer program is loaded and executed by the processor to implement operations performed in the method for generating reply information in the foregoing embodiments.

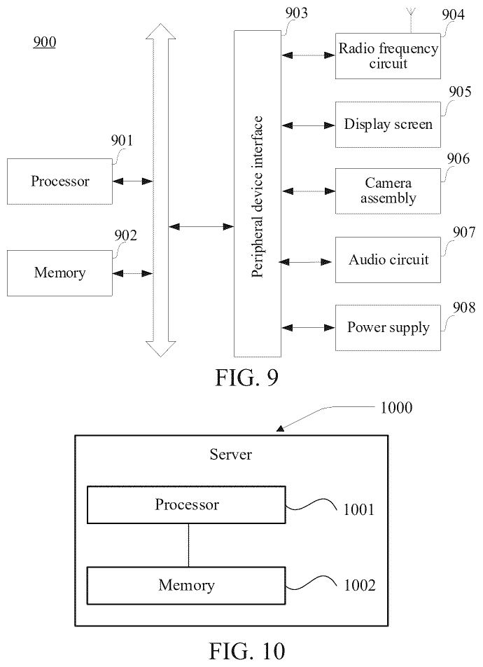

In one embodiment, the computer device is provided as a terminal. FIG. 9 shows a structural block diagram of a terminal 900 according to an exemplary embodiment of this application. The terminal 900 includes a processor 901 and a memory 902.

The processor 901 may include one or more processing cores, for example, may be a 4-core processor or an 8-core processor. The processor 901 may be implemented by using at least one hardware form of a digital signal processing (DSP), a field programmable gate array (FPGA), or a programmable logic array (PLA). The processor 901 may also include a main processor and a co-processor. The main processor is a processor configured to process data in a wakeup state, and is also referred to as a central processing unit (CPU). The co-processor is a low-power processor configured to process data in a standby state. In some embodiments, the processor 901 may be integrated with a graphics processing unit (GPU), and the GPU is configured to be responsible for rendering and drawing content that needs to be displayed on a display screen. In some embodiments, the processor 901 may further include an artificial intelligence (AI) processor. The AI processor is configured to process a calculation operation related to machine learning.

The memory 902 may include one or more computer-readable storage media, and the computer-readable storage media may be non-transitory. The memory 902 may include a high-speed random access memory and a nonvolatile memory, for example, one or more magnetic disk storage devices and flash memory devices. In some embodiments, the non-transitory computer-readable storage medium in the memory 902 is configured to store at least one computer program. The at least one computer program is configured to be executed by the processor 901, to implement the method for generating reply information provided in the method embodiments of this application.

In some embodiments, the terminal 900 may further include a peripheral interface 903 and at least one peripheral device. The processor 901, the memory 902, and the peripheral interface 903 may be connected to each other through a bus or a signal line. The peripheral devices may be connected to the peripheral interface 903 through the bus, the signal line, or a circuit board. Specifically, the peripheral device includes at least one of a radio frequency circuit 904, a display screen 905, a camera assembly 906, an audio circuit 907, and a power supply 908.

The peripheral interface 903 may be configured to connect at least one peripheral device related to input/output (I/O) to the processor 901 and the memory 902. In some embodiments, the processor 901, the memory 902, and the peripheral interface 903 are integrated on a same chip or circuit board. In some other embodiments, any one or two of the processor 901, the memory 902, and the peripheral interface 903 may be implemented on an independent chip or circuit board. This is not limited in this embodiment.

The radio frequency circuit 904 is configured to receive and transmit a radio frequency (RF) signal, which is also referred to as an electromagnetic signal. The radio frequency circuit 904 communicates with a communication network and another communication device through the electromagnetic signal. The radio frequency circuit 904 converts an electrical signal into the electromagnetic signal for transmission, or converts a received electromagnetic signal into the electrical signal. In one embodiment, the radio frequency circuit 904 includes: an antenna system, an RF transceiver, one or more amplifiers, a tuner, an oscillator, a digital signal processor, a codec chip set, a subscriber identity module card, and the like. The radio frequency circuit 904 may communicate with another terminal through at least one wireless communication protocol. The wireless communication protocol includes, but is not limited to, World Wide Web, a metropolitan area network, an intranet, mobile communication networks of all generations (2G, 3G, 4G, and 5G), a wireless local area network, and/or a wireless fidelity (Wi-Fi) network. In some embodiments, the radio frequency circuit 904 may further include a circuit related to near field communication (NFC). This is not limited in this application.

The display screen 905 is configured to display a user interface (UI). The UI may include a graph, a text, an icon, a video, or any combination thereof. When the display screen 905 is a touch display screen, the display screen 905 further has a capability of collecting a touch signal on or above a surface of the display screen 905. The touch signal may be inputted to the processor 901 as a control signal for processing. In this case, the display screen 905 may further be configured to provide a virtual button and/or a virtual keyboard, also referred to as a soft button and/or a soft keyboard. In some embodiments, there may be one display screen 905, and the display screen 905 is disposed on a front panel of the terminal 900. In some other embodiments, there may be at least two display screens 905 that are respectively disposed on different surfaces of the terminal 900 or disposed in a folded design. In some other embodiments, the display screen 905 may be a flexible display screen, and is disposed on a curved surface or a folded surface of the terminal 900. In addition, the display screen 905 may be configured to be a non-rectangular irregular figure, that is, a special-shaped screen. The display screen 905 may be prepared by using a material such as a liquid crystal display (LCD) or an organic light-emitting diode (OLED).

The camera assembly 906 is configured to collect an image or a video. In one embodiment, the camera assembly 906 includes a front camera and a rear camera. The front camera is disposed on the front panel of the terminal, and the rear camera is disposed on a back surface of the terminal. In some embodiments, there are at least two rear cameras, which are respectively any one of a main camera, a depth-sensing camera, a wide-angle camera, and a telephoto camera, to fuse the main camera and the depth-sensing camera to implement a background blur function, fuse the main camera and the wide-angle camera to implement panorama photographing and a virtual reality (VR) photographing function, or implement another fusion photographing function. In some embodiments, the camera assembly 906 may further include a flashlight. The flashlight may be a single color temperature flashlight, or may be a dual color temperature flashlight. The dual color temperature flashlight refers to a combination of a warm-light flashlight and a cool-light flashlight, and can be configured for light compensation in different color temperatures.

The audio circuit 907 may include a microphone and a speaker. The microphone is configured to collect sound waves of a user and an environment, convert the sound waves into the electrical signal, and input the electrical signal to the processor 901 for processing, or input the electrical signal to the radio frequency circuit 904 for implementing voice communication. For the purpose of stereophonic sound collection or noise reduction, there may be a plurality of microphones, and the microphones are respectively disposed at different parts of the terminal 900. The microphone may also be an array microphone or an omnidirectional collection microphone. The speaker is configured to convert an electrical signal from the processor 901 or the radio frequency circuit 904 into a sound wave. The speaker may be a conventional film speaker, or may be a piezoelectric ceramic speaker. When the speaker is the piezoelectric ceramic speaker, the speaker can not only convert the electric signal into a sound wave audible to human, but also convert the electric signal into a sound wave inaudible to human for purposes such as ranging. In some embodiments, the audio circuit 907 may further include a headset jack.

The power supply 908 is configured to supply power to components in the terminal 900. The power supply 908 may be an alternating current, a direct current, a single-use battery, or a rechargeable battery. When the power supply 908 includes the rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may further be configured to support a fast charging technology.

A person skilled in the art may understand that the structure shown in FIG. 9 constitutes no limitation on the terminal 900, and the terminal may include more or fewer components than those shown in the figure, or some components may be combined, or a different component deployment may be used.

In one embodiment, the computer device is provided as a server. FIG. 10 is a schematic structural diagram of a server according to an embodiment of this application. The server 1000 may vary greatly due to different configurations or performance, and may include one or more central processing units (CPUs) 1001 and one or more memories 1002. The memory 1002 stores at least one computer program. The at least one computer program is loaded and executed by the processor 1001 to implement the methods provided in the foregoing method embodiments. Certainly, the server may further have components such as a wired or wireless network interface, a keyboard, and an input/output interface, to perform input/output. The server may further include other components configured to implement functions of the device. Details are not described herein again.

An embodiment of this application further provides a non-transitory computer-readable storage medium. The computer-readable storage medium stores at least one computer program. The at least one computer program is loaded and executed by a processor to implement operations performed by the method for generating reply information in the foregoing embodiments.

An embodiment of this application further provides a computer program product. The computer program product includes a computer program. When the computer program is executed by a processor, operations performed by the method for generating reply information according to the foregoing embodiments are implemented.

A person of ordinary skill in the art may understand that all or some of the operations of the foregoing embodiments may be implemented by using hardware, or may be implemented by a program instructing relevant hardware. The program may be stored in a non-transitory computer-readable storage medium. The storage medium mentioned above may be a read-only memory, a magnetic disk, an optical disc, or the like.

The foregoing descriptions are merely exemplary embodiments of embodiments of this application, but are not intended to limit embodiments of this application. Any modification, equivalent replacement, or improvement made within the spirit and principle of embodiments of this application shall fall within the protection scope of this application.

What is claimed is:

1. A method for generating reply information performed by a computer device, the method comprising:
classifying dialogue information to obtain a first category indicating a plurality of target dialogue models and a second category indicating a general dialogue model;
performing semantic analysis on the dialogue information through a large language model to obtain semantic information of the dialogue information;
determining, based on the semantic information, a first intention type from a plurality of intention types, the first intention type matching the semantic information; and
generating first reply information to the dialogue information through a target dialogue model of the first intention type.

2. The method according to claim 1, wherein each target dialogue model is configured for replying to dialogue information of one intention type.

3. The method according to claim 1, wherein the dialogue information is question information; and the performing semantic analysis on the dialogue information through a large language model to obtain semantic information of the dialogue information comprises:
identifying a question type of the question information through the large language model;
classifying the question information through the large language model, to obtain a second intention type, the second intention type being one intention type of the plurality of intention types that matches the question type; and
constituting the semantic information by combining the second intention type and the question type through the large language model.

4. The method according to claim 3, wherein before the constituting the semantic information by combining the second intention type and the question type through the large language model, the method further comprises:
identifying at least one of a topic of the question information, an entity word in the question information, or a word type of the entity word through the large language model; and
constituting the semantic information by combining at least one of the topic, the entity word, or the word type, and the second intention type and the question type through the large language model.

5. The method according to claim 1, wherein the determining, based on the semantic information, a first intention type from a plurality of intention types comprises:
querying a type mapping table based on the semantic information, the type mapping table comprising a question type corresponding to each intention type of the plurality of intention types; and
determining the second intention type as the first intention type when a target question type comprises a question type in the semantic information, the target question type being a question type corresponding to the second intention type in the type mapping table.

6. The method according to claim 1, wherein before the performing semantic analysis on the dialogue information through a large language model to obtain semantic information of the dialogue information, the method further comprises:
obtaining first indication information, the first indication information indicating the large language model to perform semantic analysis on inputted information according to an example of semantic analysis, and the example comprising an inputted information example and a semantic information example of the inputted information example; and
performing semantic analysis on the dialogue information based on the first indication information through the large language model when the category of the dialogue information is the first category, to obtain the semantic information of the dialogue information.

7. The method according to claim 1, wherein after the classifying dialogue information to obtain the first category and the second category, the method further comprises:
generating second reply information to the dialogue information through the general dialogue model when the category of the dialogue information is the second category.

8. The method according to claim 1, wherein after the performing semantic analysis on the dialogue information through a large language model to obtain semantic information of the dialogue information, the method further comprises:
generating second reply information to the dialogue information through the general dialogue model when the plurality of intention types do not match the semantic information.

9. The method according to claim 1, wherein the method further comprises:
obtaining sample dialogue information and second indication information, the second indication information indicating a semantic analysis model to perform semantic analysis on the inputted information according to the example of semantic analysis;
performing semantic analysis on the sample dialogue information based on the second indication information through the semantic analysis model, to obtain sample semantic information;
performing semantic analysis on the sample dialogue information through the large language model, to obtain predicted semantic information; and
training the large language model based on the predicted semantic information and the sample semantic information.

10. A computer device, comprising a processor and a memory, the memory storing at least one computer program, and the at least one computer program, when executed by the processor, causing the computer device to implement a method for generating reply information including:
classifying dialogue information to obtain a first category indicating a plurality of target dialogue models and a second category indicating a general dialogue model;
performing semantic analysis on the dialogue information through a large language model to obtain semantic information of the dialogue information;
determining, based on the semantic information, a first intention type from a plurality of intention types, the first intention type matching the semantic information; and
generating first reply information to the dialogue information through a target dialogue model of the first intention type.

11. The computer device according to claim 10, wherein each target dialogue model is configured for replying to dialogue information of one intention type.

12. The computer device according to claim 10, wherein the dialogue information is question information; and the performing semantic analysis on the dialogue information through a large language model to obtain semantic information of the dialogue information comprises:
identifying a question type of the question information through the large language model;
classifying the question information through the large language model, to obtain a second intention type, the second intention type being one intention type of the plurality of intention types that matches the question type; and
constituting the semantic information by combining the second intention type and the question type through the large language model.

13. The computer device according to claim 12, wherein before the constituting the semantic information by combining the second intention type and the question type through the large language model, the method further comprises:
identifying at least one of a topic of the question information, an entity word in the question information, or a word type of the entity word through the large language model; and
the constituting the semantic information by combining the second intention type and the question type through the large language model comprising:
constituting the semantic information by combining at least one of the topic, the entity word, or the word type, and the second intention type and the question type through the large language model.

14. The computer device according to claim 10, wherein the determining, based on the semantic information, a first intention type from a plurality of intention types comprises:
querying a type mapping table based on the semantic information, the type mapping table comprising a question type corresponding to each intention type of the plurality of intention types; and
determining the second intention type as the first intention type when a target question type comprises a question type in the semantic information, the target question type being a question type corresponding to the second intention type in the type mapping table.

15. The computer device according to claim 10, wherein before the performing semantic analysis on the dialogue information through a large language model to obtain semantic information of the dialogue information, the method further comprises:
obtaining first indication information, the first indication information indicating the large language model to perform semantic analysis on inputted information according to an example of semantic analysis, and the example comprising an inputted information example and a semantic information example of the inputted information example; and
performing semantic analysis on the dialogue information based on the first indication information through the large language model when the category of the dialogue information is the first category, to obtain the semantic information of the dialogue information.

16. The computer device according to claim 10, wherein after the classifying dialogue information to obtain the first category and the second category, the method further comprises:
generating second reply information to the dialogue information through the general dialogue model when the category of the dialogue information is the second category.

17. The computer device according to claim 10, wherein after the performing semantic analysis on the dialogue information through a large language model to obtain semantic information of the dialogue information, the method further comprises:
generating second reply information to the dialogue information through the general dialogue model when the plurality of intention types do not match the semantic information.

18. The computer device according to claim 10, wherein the method further comprises:
obtaining sample dialogue information and second indication information, the second indication information indicating a semantic analysis model to perform semantic analysis on the inputted information according to the example of semantic analysis;
performing semantic analysis on the sample dialogue information based on the second indication information through the semantic analysis model, to obtain sample semantic information;
performing semantic analysis on the sample dialogue information through the large language model, to obtain predicted semantic information; and
training the large language model based on the predicted semantic information and the sample semantic information.

19. A non-transitory computer-readable storage medium storing at least one computer program, and the at least one computer program, when executed by a processor of a computer device, causing the computer device to implement a method for generating reply information including:
classifying dialogue information to obtain a first category indicating a plurality of target dialogue models and a second category indicating a general dialogue model;
performing semantic analysis on the dialogue information through a large language model to obtain semantic information of the dialogue information;
determining, based on the semantic information, a first intention type from a plurality of intention types, the first intention type matching the semantic information; and
generating first reply information to the dialogue information through a target dialogue model of the first intention type.

20. The non-transitory computer-readable storage medium according to claim 19, wherein each target dialogue model is configured for replying to dialogue information of one intention type.
